(19) United States
(12) Patent Application Publication
(10) Pub. No.: US 2010/0303148 A1
(43) Pub. Date: Dec. 2, 2010

(54) MACROBLOCK-BASED DUAL-PASS CODING METHOD

(76) Inventors: Franck Hiron, Chateaubourg (FR); Yannick Olivier, Thorigne Fouillard (FR); Philippe Guillotel, Vern Sur Seiche (FR)

Correspondence Address: Robert D. Shedd, Patent Operations;THOMSON Licensing LLC, P.O. Box 5312, Princeton, NJ, 08543-5312, US

(21) Appl. No.: 12/735,102

(22) PCT Filed: Dec. 2, 2008
(86) PCT No.: PCT/FR2008/052175

§ 371 Date: Jun. 16, 2010

(30) Foreign Application Priority Data
Dec. 21, 2007 (FR) 0760308

(51) Int. Cl. H04N 7/26

(52) U.S. Cl. 375/240.03; 375/E07.126

(57) ABSTRACT

The method comprises the following steps:
during the first pass, a memorization of the M best coding modes and their coding parameters per image macroblock,
during the second pass, a calculation, according to the new quantization step determined by the regulating algorithm according to the parameters memorized, among the M coding modes memorized, of the coding mode minimising the bitrate-distortion criterion, to select it,
a coding according to the selected coding mode.

The applications relate to the compression of data.

### SCOPE OF THE INVENTION

The present invention relates to the field of video compression.

It relates to a method for coding according to several passes of a video image sequence, the coding being carried out per image macroblock according to an MPEG standard, a bitrate-distortion criterion being calculated for a coding mode during the first pass.

### PRIOR ART

A dual pass coding method is known to the prior art that consists in coding a video image sequence twice.

The coding methods use, in particular when they are compatible with an MPEG standard, a regulation at GOP level, at constant or variable bitrate. A GOP (Group Of Pictures) is a group of images comprised between 2 intra type images, I or IDR, defined in the MPEG standards such as MPEG2 or MPEG4. A memory or buffer at the output of the coder, generally of the size of the GOP, enables the output bitrate to be regulated, absorbing the bitrate variations between images caused by their variable complexity.

In CBR (Constant Bit-Rate), the compression rate is constant and the image quality varies. If a good image quality is desired throughout the coded sequence, that is to say over the “difficult” passages to be coded corresponding to complex images, it is necessary to use a low compression rate on the entire sequence enabling a correct level of quality for the difficult passages having a high level of motion or with very textured images. This means that some static scenes will be coded to provide a higher bitrate than that which would have been necessary to maintain a same quality of images. There is therefore no optimization of coding cost or bandwidth according to the quality of images. This coding mode is used for example in satellite or terrestrial broadcast applications such as terrestrial digital television.

The principle of VBR (Variable Bit-Rate) is to maintain if possible a constant quality and to vary the compression rate. The scenes that are easy to code, for example the static scenes, are thus coded with a high compression rate and the more difficult scenes are coded with a lower compression rate, while recuperating in a way the coding cost or bitrate saved on the static scenes. This requires knowing the coding cost of different scenes. This mode is used for example for storage applications on DVD (Digital Versatile Disc), from a PVR (Personal Video Recorder), etc.

The advantage of a dual pass VBR method over the single pass or mono pass method is the possibility to “recuperate” bitrate on one scene to assign it to another.

In single pass VBR mode, a buffer of limited size is used. The coder estimates the compression difficulty, that is to say the cost of coding the scenes or images memorized in this memory and varies the compression rate according to this information. Finally, the coder can only compensate a low compression rate, associated with an animated scene, with a high compression rate, for a static scene, if these two scenes are found simultaneously in the buffer memory. In the contrary case, if there are only complex scenes in the memory, the coder is obliged to vary the quality of the images, for example by increasing the quantization step to reduce the bitrate.

In the case of a coding in a single pass, the coder can not know in advance the complexity of the image to be coded. It therefore makes predictions to estimate the coding costs of the following images. This prediction is satisfactory when the sequence is stable. It can not anticipate statistical changes such as shot changes.

The dual pass VBR mode uses a first and a second coding of a same image. The first pass is used to determine the bitrate necessary for the encoding of each image. Thus the bitrate can be distributed between the images according to the target bitrate, which is the average bitrate, in a more optimal way than with a single pass that has no information on the images that will follow.

The dual pass VBR mode, when not working in real time, can be considered as a single pass VBR mode for which the buffer memory will be a memory of unlimited capacity and that could therefore contain the sequence or the film in its entirety. The coder carries out a first pass to estimate the difficulty of coding the set of sequences of the film to be compressed. During the second pass, the compression step itself, the coding algorithm can assign a higher bitrate to a dynamic scene at the start of the film knowing that this surplus of bitrate can be recuperated during a static scene at the end of the film. This is because a static scene was detected during the first pass.

For coding in real time, the gains obtained in the processing capacity of integrated circuits have enabled dual pass coding to be realized in MPEG-2 type coders. However the complexity of new standards such as H.264/AVC does not permit such a dual pass coding in real time, whatever the hardware or software configurations.

An intermediary solution consists in the implementation of a simplified dual pass algorithm using a first pass carrying out a coding for which the mode is predefined. The algorithm is two “partial” passes that is to say using a partial coding during the first pass, consists for example in a coding in forced intra mode of images during the first pass. The coding in two “complete” passes is generally not compatible with a processing in real time.

In the case of a partial coding, the estimation is less precise but this coding nevertheless provides some information on the evolution of the sequence. The first pass however does not enable the real complexity of the coded images to be evaluated, that is to say that corresponding to the coding modes selected during the second pass, most frequently the inter modes.

In a dual pass coding context, information from the first pass is attempted to be used to optimise the decision relating to the coding mode of the macroblock and not only for the regulation of the bitrate. The decision on the coding mode of a macroblock is made for example according to the following two criteria:
the image quality, in terms of difference with the original source image,
the cost, in terms of bitrate.

The Lagrangian optimization technique on a function or bitrate-distortion criterion enables such an approach. It is by minimizing the equation (1) that the coding mode is determined:

J=D+λR (1)

where:
D, a measurement parameter of distortion of the image, inverse of the quality, for example the sum of the absolute value of differences, pixel by pixel, between the reconstructed or recoded image and the source image, also called SAD (Sum of Absolute Difference),
R, a bitrate, an estimation or real cost of coding, for example in number of bits necessary for the coding,
Lambda (λ), the Lagrangian parameter.

In an example, the value of λ is calculated using an empirical formula: λ=0.85×2^{(QP-12)/3} wherein QP is the quantization step of DCT coefficients of the macroblock.

The coding of the first pass is carried out using a certain number of parameters, for example the quantization step. However the value of these parameters, modified during the second pass, is taken into account for the coding mode decision for this second pass:
the value of lambda depends on the quantization step (QP),
the measurement of the quality depends on the local decoded image that is different during the second pass.

Taking into account a coding not reflecting that of the second pass introduces a bias. The decision is taken during the first pass even though the environment during the second pass, the local decoded image, the quantization, etc. may be different.

It is not on the other hand possible to carry out the coding set corresponding to the different possible coding modes of the macroblocks. In fact, the number of coding modes per macroblock is generally very high.

Let us take the example of the H.264/AVC standard:
in Intra mode, there are 9 predictors per 4×4 block +9 predictors per 8×8 block +4 predictors per 16×16 block
in type P Inter mode, the prediction can be of type forward prediction, backward prediction or bidirectional, the mode can be of type direct or of type skip, over N possible reference images and for 4 partitions of size 16×16, 16×8, 8×16, 8×8 and possibly 3 sub-partitions of size 8×4, 4×8, 4×4.

On the other hand, the images can be coded in field mode, with top field or bottom field predictions for the two fields, in frame mode, thus multiplying the number of predictions by 5.

Finally each macroblock can then use a discrete cosine transform either on a block of size 4×4, or on a block of size 8×8.

For a P type image using a single reference (N=1), almost one thousand coding modes are possible. By using 3 image references, more is than five thousand coding modes are possible. For a B type image this number is even greater due to additional coding modes such as the bidirectional mode, the direct mode, etc.

The use of a first pass to decide the coding parameters of the second pass provides a substantial gain in terms of quality and particularly on the temporal stability of the bitrate regulation. However, the fact of not calling into question the coding decision taken during the first pass is a generator of losses in the levels of quality, compression rate or bitrate. The table below corresponds to simulations and represents the loss that can be generated when the first pass coding decision is not questioned.

The calculation is carried out by realizing a first pass coding using a quantization step QP. It is supposed then that the results of this first pass require an adjustment of the quantization step for the second pass coding. The quantization step is thus modified during the second pass in a uniform manner over the entire image. For this simulation, the bitrate regulation is thus not used. This offset with respect to the first pass quantization step can correspond to that which will determine a bitrate regulation to attain a bitrate target. The adjustments taken into account here are a single and double decrementation and incrementation of the quantization step.

The first column defines the sequence types known to those skilled in the art of video compression. The other columns corresponding, for different quantization steps around the quantization step selected for the first pass, to the bitrate losses. This means the bitrate difference between a second pass coding not questioning the coding mode of the first pass, that is to say using the same coding mode as that of the first pass but with a quantization step (QP+1, QP−1, etc.) other than that QP used for the first pass and a second pass coding using the best coding mode, that is to say questioning the coding mode decision of the first pass, with this different quantization step. The first pass coding is supposed to select the most efficient coding mode for a predefined quantization step QP.

It is noted that a change in the quantization step, even a modest one, can lead to a significant loss of bitrate or image quality. For example for the auto sequence, the bitrate is increased by approximately 7%, with respect to that obtained during the first pass, when the quantization step is decremented.

| | QP −2 | QP −1 | QP +1 | QP +2 |
|---|---|---|---|---|
| auto+ | 9.59 | 7.13 | 5.84 | 7.88 |
| tennis+ | 8.4 | 5.6 | 4.91 | 7.75 |
| bigdil+ | 5.1 | 4.22 | 4.39 | 5.89 |
| defile | 9.6 | 6.52 | 5.63 | 7.21 |
| patin1 | 10.6 | 7.93 | 6.04 | 7.95 |
| patin2 | 10.96 | 8.29 | 6.74 | 8.28 |
| flower+ | 5.36 | 4.3 | 3.66 | 4.82 |
| mobile+ | 5.45 | 4.07 | 3.13 | 4.28 |
| fbal1+ | 7.79 | 5.97 | 5.21 | 7.04 |
| girls | 7.61 | 5.29 | 6.09 | 8.02 |
| stefan | 6.98 | 5.52 | 5.59 | 7.11 |
| avr | 7.95 | 5.89 | 5.20 | 6.93 |

### SUMMARY OF THE INVENTION

One of the purposes of the invention is to overcome the aforementioned disadvantages. The purpose of the invention is a dual pass coding method for a video image sequence, the coding being carried out per image macroblock according to the MPEG standard, a regulating algorithm regulating the bitrate by modification of a quantization step of transform coefficients of an image block, the first pass carrying out the calculation of the best coding modes, for a quantization step calculated by a first pass regulating algorithm, while minimising a bitrate-distortion criterion characterized in that it comprises the following steps:
during the first pass, a memorization of the M best coding modes and their coding parameters per image macroblock,
during the second pass, a calculation, according to the new quantization step determined by the regulating algorithm according to the parameters memorized, among the M coding modes memorized, of the coding mode minimising the bitrate-distortion criterion, to select it,
a coding according to the selected coding mode.

According to a particular embodiment, the regulation is carried out for a quantity N of images, N being a natural integer, these images being memorised during the duration of the first pass coding.

According to a particular embodiment, the M best coding modes memorised are at least the best coding modes in inter mode, in intra mode, in skip mode and in direct mode.

According to a particular embodiment, the parameters memorised are the quantization step, the coding cost and the measurement of quality.

According to a particular embodiment, the bitrate-distortion criterion is defined by the distortion function:

J=D+λR

where:
D, is a distortion measurement parameter,
R, is a coding cost,
Lambda (λ), is the Lagrangian parameter.

According to a particular embodiment, the distortion measurement parameter is the sum of the absolute value of differences or SAD.

According to a particular embodiment, the Lagrangian parameter is defined by the equation:

λ=0.85×2^{(QP-12)/3}

in which QP is the quantization step of the image macroblock.

According to a particular embodiment, the calculation of the coding mode minimising the bitrate-distortion criterion consists in an estimation of the bitrate-distortion criterion carried out by replacing the Lagrangian to parameter with its new value according to the new quantization step, the other values D and R being those obtained during the first pass.

The idea of the invention is to recalculate the coding decision taken during the first pass taking into account the new quantization step defined during this first pass. The method consists, during the first pass, in storing the M best decisions, those that minimise the bitrate-distortion function, with quality and cost information on each. During the second pass, these M decisions are taken into account to select the best, according to the new environment and new constraints. The solution proposed enables a simplification with respect to a complete dual pass coding while providing an improvement in coding efficiency with respect to a partial dual pass coding such as is described above. The calculation time and costs are reduced as only the most efficient modes of the first pass are recalculated. Moreover, a standard dual pass architecture can be used. The coding mode is optimised at macroblock level, the compression rate or image quality is improved.

### BRIEF DESCRIPTION OF THE DRAWINGS

Other characteristics and advantages of the invention will emerge in the following description provided as a non-restrictive example, and referring to the annexed drawings wherein:

FIG. 1 a coding schema for the first pass,

FIG. 1 a coding schema for the second pass.

### DETAILED DESCRIPTION OF THE EMBODIMENTS OF THE INVENTION

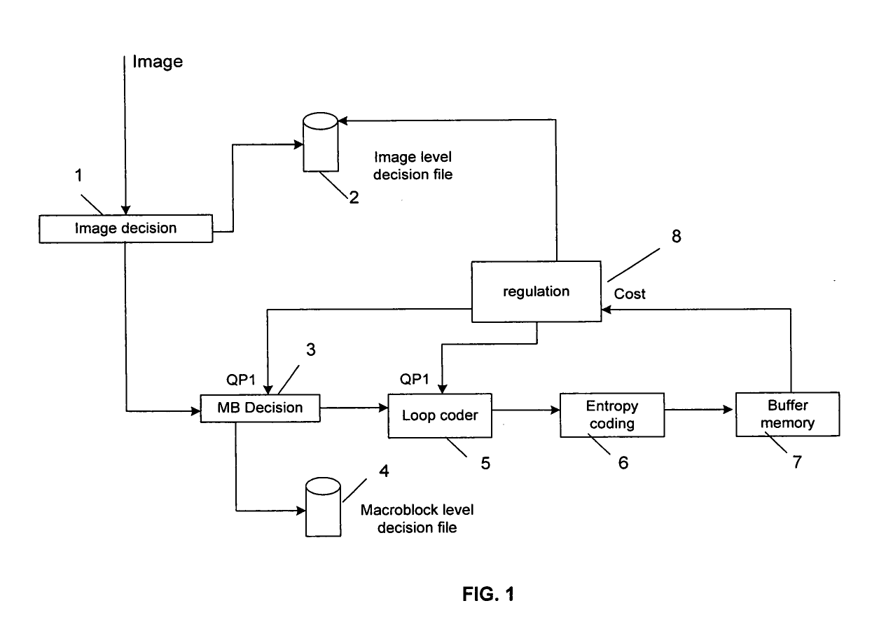

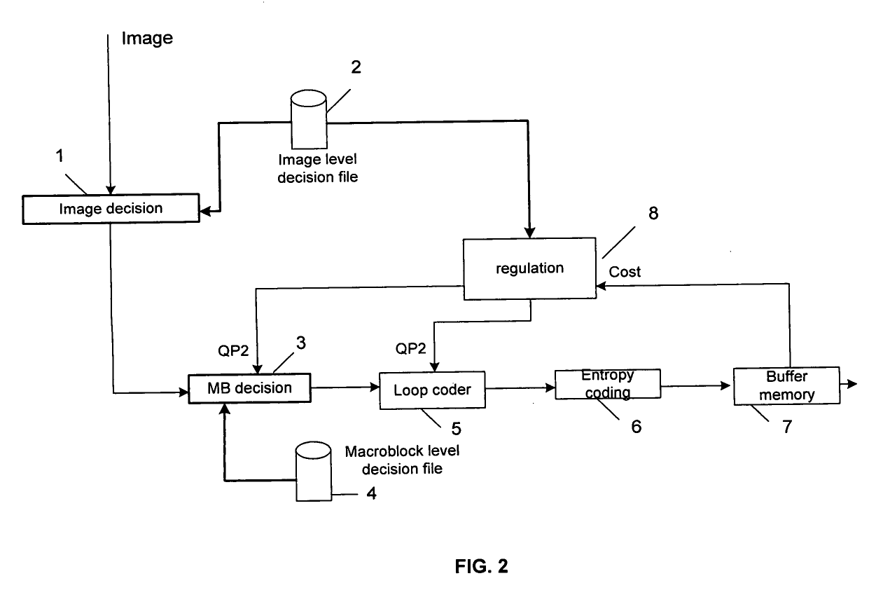

FIGS. 1 and 2 diagrammatically show, a coder implementing the different steps of the method according to the invention, FIG. 1 corresponding to the method during the first pass and FIG. 2 corresponding to the method during the second pass.

The images of the sequence of images to be compressed are transmitted to the input of the device connected to the input of a reference image decision circuit 1. This circuit carries out, among others, a selection of the GOP structure, if it is of variable structure. It selects the coding mode of the image, in frame mode of field mode and carries out the de-interleaving if necessary. These different selections are memorised in a memory or decision storage file at image level, referenced 2, to be used during the second pass.

The image is then transmitted, macroblock by macroblock, to the input of the MB decision circuit referenced 3. This circuit implements the different intra and inter coding modes of a macroblock, to decide the best coding mode. In the MPEG4 AVC standard, the intra modes are related to the blocks of size 4×4, 8×8, 16×8, 8×16 and 16×16. The inter coding modes are for example of unidirectional type, in anticipated or differed prediction, bidirectional and take into account one or more reference images. In one particular embodiment, the MB decision circuit comprises an MPEG type coding circuit, carrying out the coding in the different modes and carrying out the different calculations of motion estimation, image reconstruction, prediction, etc. The decision circuit calculates, for each mode, the bitrate-distortion function and selects the M coding modes providing the values that are then memorised in the memory or decision storage file at macroblock level referenced as 4, with attenuated quality and cost information. This storage is carried out macroblock by macroblock. Other decision modes can be used, exploiting or not the different steps of MPEG coding. It is for example possible to use the Hadamard transform, by calculating a SAID (Sum of Absolute Transformed Differences) that corresponds to the sum of the absolute value of Hadamard transform coefficients differences, differences between the source block and the predicted block. A simple SAD between the block of source pixels and the block that is coded then decoded can also be calculated to measure the quality of the block.

The calculation procedure can consist for example in dividing the macroblock into blocks of size 8×8 and in, calculating the motion blocks for each of these blocks then in “going back up” to bigger sized blocks of 8×16, 16×8, 16×16. For each of the partitions, blocks 4×4, 8×8, 16×8, 8×16 and 16×16, a calculation in intra, inter mode is carried out, the values of the bitrate-distortion criterion, for example those corresponding to the equation 1, are calculated. The best coding modes are memorised for these partitions with the corresponding parameters such as the motion vectors, reference images, etc. The “skip” and “direct” coding modes can also be taken into account. The best modes at macroblock level are calculated and memorised. For the measurement of cost, the headers, the motion vectors and the coefficients are generally taken into account. But a more global and thus less precise calculation can also be carried out, based on estimative methods, for example of the type known as “a priori”. Such “a priori” algorithms are described in the standardization document ITU-T Recommendation H.264.2, entitled “Reference software for H.264 advanced video coding”

Information relating to the best coding mode is transmitted with the luminance macroblock to a coding loop 5 that carries out a coding according to the MPEG standard and according to this best mode. It involves in a manner known to the prior art, inter or intra coding producing a discrete cosine transform, a quantization, a reconstruction of the image to provide a predicted image used for the coding in inter mode, a calculation of residues, etc. The macroblock of quantized coefficients leaving the coder loop is transmitted to an entropy coding circuit 6 that produces in a known manner a coding of variable length of VLC (Variable Length Coding) type. The output of this coder 6 is connected to a buffer memory 7 for which the filling level is linked to the coding cost of macroblocks. This level information is transmitted to a regulating circuit 8 whose main task is to calculate the quantization step that must be used by the coder loop 4, the variation of the quantization step enabling the regulation. The regulating algorithm implemented by the regulating circuit compares the bitrate with the target and acts on the quantization step to carry out this regulation. This quantization step is thus transmitted to the coder loop 5 but also to the coding mode decision circuit 3 that uses it to optimise the coding mode decision according to the quantization step. The regulating circuit also provides information of the quantization step, the cost per image, complexity and image quality to the storage file at image level 2 that memorises it for each image.

FIG. 2 shows this same coding device used during the second pass. The same numbering is used.

The source images are transmitted at the device input to be sent towards the image decision circuit 1. These source images coming from a memorisation circuit, not represented on the figure, that memorises in a FIFO memory a determined quantity of source images to retransmit them to the coding device during the second pass, with a delay corresponding to the number of images memorised. This number that can correspond to the size of a GOP, can depend on application constraints, for example of the contribution coder.

These images can be memorised, during the first pass, with the decision parameters of the coding mode at image level, in the storage file at image level 2. The second pass is then carried out on the data read of this storage file or FIFO memory, data written during the first pass.

The image decision information corresponding to the image to be processed during this second pass are recovered from this storage file 2, information such as image type I, P or B, the field or frame mode, etc. by the image decision circuit 1 that transmits the macroblocks corresponding to the coding type of the image to the MB decision circuit 3. This circuit recovers the best coding modes with their parameters from the coding mode decision file at the level of macroblock 4.

The calculations are carried out, during this second pass, with the new quantization step provided by the regulating circuit 8. The regulating algorithm of the regulating circuit 8 is a second pass regulating algorithm. The regulation of bitrate is made according to information memorised during the first pass, information of the quantization step, the cost per image, the complexity, the image quality, the cost per macroblock, the quality of the macroblock, etc.

For example, though, during the first pass, the regulating algorithm can be limited to a calculation of the quantization step according to the target bitrate, the coding cost and the image quality, this other second pass regulating algorithm can use the information obtained on the following images, during the first pass, to adjust the quantization step of the current image. For example, a camera flash in a sequence causes an increase in the coding cost by deleting the temporal correlation and thus causes, during the first pass, an increase in the quantization step. This flash is taken into account, on the GOP or on the number of images on which the regulation is performed, for example the number of images for which are memorised the parameters, to distribute this point of coding cost through the set of images, for example by increasing the quantization step calculated for the other images and reducing it for the image that is costly in coding, reducing the quality of the other images to increase that of the image that is costly in coding.

These quantization step variations, with respect to the first pass, as indicated above, render non-optimal the coding mode decisions taken during the first pass. The coding modes corresponding to the best coding in intra mode, to the best coding in bidirectional inter mode and directional inter mode, the skip mode and the direct mode were memorised during the first pass and as were the parameters relating to these modes. They are now recovered from the decision file at the level of macroblock 4 by the MB decision circuit 3.

Several best inter, intra or other coding modes were able to be memorised. For each of the M modes memorised, the coding mode decision circuit carries out the calculation of the bitrate-distortion function by taking into account the new quantization step on which depends λ and by also taking into account the information on cost and quality from the regulating circuit 8. The best mode minimizing this bitrate-distortion function =D+λR, is selected.

The macroblock is transmitted, with the selected coding mode, to the loop coding circuit 5 that carries out the effective coding of the macroblock according to this best coding mode selected during this second pass. The data coded at the output of the loop coder 5 are transmitted to the entropy coder 6 and to the buffer memory 7 to be available at the coder output. The buffer memory 7 also transmits the information on the filling level of the regulating circuit 8 to carry out the regulation.

The choice of best coding modes is not restrictive. It may concern the single best inter mode and the best intra mode or the single best inter mode and the best intra 4×4 and intra 8×8 modes. Special modes can be taken into account, direct mode, skip mode, etc. It is thus possible, after modification of the quantization step, that the skip or direct mode, not very costly, are selected instead of an inter or intra mode. The direct or skip mode, if selected during the first pass, can also be re-used during the second pass. In fact, the skip mode, when selected during the first pass, can be a generator of strong distortions in the image if it is maintained, a new quantization step being able to no longer justify the skip mode, for example a weaker quantization step no longer rendering the block coefficients null.

The number of best coding modes selected can be limited to a predetermined N value or it can be adaptive. This number can be dynamically variable, according for example to the calculation complexity, particularly for real time software application implementations.

In a first variant, the effective distortion is not recalculated. It is replaced by an estimation of the bitrate-distortion criterion from the mathematical function, by replacing the value of lambda with that corresponding to the new quantization step. The complexity of calculations is thus reduced. In other words, the values R and D obtained during the first pass are exploited for the calculation of the bitrate-distortion criterion and only the lambda parameter is updated according to the new quantization step, for the calculation.

In a second variant, the first pass produces an estimation of the bitrate-distortion criterion using an a priori algorithm and the second pass carries out a real calculation on the few modes selected using an a posteriori algorithm.

In a third variant, the calculation of the MB decision of the second pass also takes into account the coding mode decisions for the neighbouring macroblocks and/or the co-located macroblocks. The coding predictions can be taken into account for the next macroblocks to be coded. This is in order to homogenise the MB structure, the coding modes, the coding parameters, etc. spatially and in time, and thus gain in subjective quality.

1. Dual pass coding method for a video image sequence, the coding being carried out per image macroblock according to the MPEG standard, a regulating algorithm regulating the bitrate by modification of a quantization step of transform coefficients of an image block, the first pass carrying out the calculation of the best coding modes, for a quantization step calculated by a first pass regulating algorithm, while minimising a bitrate-distortion criterion, characterized in that it comprises the following steps:
during the first pass, a memorization of the M best coding modes and their coding parameters per image macroblock,
during the second pass, a calculation, according to the new quantization step determined by the regulating algorithm according to the parameters memorized, among the M coding modes memorized, of the coding mode minimising the bitrate-distortion criterion, to select it,
a coding according to the selected coding mode.

2. Method according to claim 1, wherein the regulation is carried out for a quantity N of images, N being a natural integer, these images being memorised during the duration of the first pass coding.

3. Method according to claim 1, wherein the M best coding modes memorised are at least the best coding modes in inter mode, in intra mode, in skip mode and in direct mode.

4. Method according to claim 1, wherein the parameters memorised are the quantization step, the coding cost and the measurement of quality.

5. Method according to claim 1, wherein the bitrate-distortion criterion is defined by the distortion function:
J=D+λR
where:
D, is a distortion measurement parameter,
R, is a coding cost,
Lambda (λ), is the Lagrangian parameter.

6. Method according to claim 5, wherein the distortion measurement parameter is the sum of the absolute value of differences or SAD.

7. Method according to claim 5, wherein the Lagrangian parameter is defined by the equation:
λ=0.85×2^{(QP-12)/3}
in which QP is the quantization step of the image macroblock.

8. Method according to claim 5, wherein the calculation of the coding mode minimising the bitrate-distortion criterion consists in an estimation of the bitrate-distortion criterion carried out by replacing the Lagrangian parameter with its new value according to the new quantization step, the other values D and R being those obtained during the first pass.
